(19) United States
(12) Patent Application Publication
(10) Pub. No.: US 2023/0269483 A1
(43) Pub. Date: Aug. 24, 2023

(54) ELECTRONIC DEVICE AND ELECTRONIC DEVICE CONTROL METHOD

(71) Applicant: CANON KABUSHIKI KAISHA, Tokyo (JP)

(72) Inventor: Shinya TAKEICHI, Kanagawa (JP)

(21) Appl. No.: 18/166,183

(22) Filed: Feb. 8, 2023

(30) Foreign Application Priority Data
Feb. 18, 2022 (JP) 2022-023653

(51) Int. Cl. H04N 23/698; H04N 23/611; H04N 23/63; G06T 3/00

(52) U.S. Cl. CPC H04N 23/698; G06T 3/0062; H04N 23/611; H04N 23/632

(57) ABSTRACT

An electronic device acquires a wide-angle image. In a case when the wide-angle image includes a specific object, control is performed so as to display, on a screen, a partial range of the wide-angle image, being a range of a direction in which the specific object is facing, in the wide-angle image.

### CROSS REFERENCE TO PRIORITY APPLICATION

This application claims the benefit of Japanese Patent Application No. 2022-023653, filed on Feb. 18, 2022, which is hereby incorporated by reference herein in its entirety.

### BACKGROUND OF THE INVENTION

### Field of the Invention

The present invention relates to an electronic device, and to an electronic device control method.

### Description of the Related Art

Imaging devices capable of capturing images over ranges wider than a human viewing angle have become widespread in recent years. Such imaging devices can acquire wide-angle images (such as spherical panoramic images, hemispherical panoramic images, images captured up, down, left and right in a 360-degree space, as well as images captured up, down, left and right in a 180-degree space).

Wide-angle images may be distorted, and be difficult for a viewer to see. In consequence, a partial region of a wide-angle image is cut out, and is displayed as a thumbnail image. Japanese Patent No. 6665440 discloses acquiring, as a thumbnail image, a region that includes an image of a person, within a wide-angle image.

In the technique disclosed in Japanese Patent No. 6665440, the thumbnail image does not necessarily show what the photographer had intended to capture. Although for instance it is possible for the photographer to be a subject, the viewer may however fail to grasp, even though looking at the thumbnail image on which the photographer appears, what the photographer did intend to capture (for instance the shooting location and or the subject that the photographer envisaged to capture).

### SUMMARY OF THE INVENTION

It is therefore an object of the present invention to provide a technique which, in presenting a partial range of an image, allows conveying what the photographer intended to capture to a viewer who is viewing that range.

An aspect of the present invention is an electronic device, comprising: a processor; and a memory storing a program which, when executed by the processor, causes the electronic device to acquire a wide-angle image; and in a case where the wide-angle image includes a specific object, perform control so as to display, on a screen, a partial range of the wide-angle image, being a range of a direction in which the specific object is facing, in the wide-angle image.

An aspect of the present invention is an electronic device control method, comprising: an acquisition step of acquiring a wide-angle image; and a control step of, in a case where the wide-angle image includes a specific object, performing control so as to display, on a screen, a partial range of the wide-angle image, being a range of a direction in which the specific object is facing, in the wide-angle image.

Further features of the present invention will become apparent from the following description of exemplary embodiments with reference to the attached drawings.

### BRIEF DESCRIPTION OF THE DRAWINGS

FIG. 1A to FIG. 1C are diagrams illustrating a digital camera according to Embodiment 1;

FIG. 2A and FIG. 2B are diagrams illustrating a display control device according to Embodiment 1;

FIG. 3 is a flowchart of direction determination processing according to Embodiment 1;

FIG. 4A to FIG. 4G are diagrams for explaining direction determination processing according to Embodiment 1;

FIG. 5 is a flowchart of direction determination processing according to Embodiment 2;

FIG. 6A to FIG. 6F are diagrams for explaining direction determination processing according to Embodiment 2;

FIG. 7A and FIG. 7B are diagrams for explaining a rendered image and frontal directions according to Embodiment 3;

FIG. 8 is a flowchart for determining Thumbnail directions according to Embodiment 3;

FIG. 9A to FIG. 9C are diagrams for explaining an undetermined list and group lists according to Embodiment 3; and

FIG. 10A and FIG. 10B are diagrams for explaining a screen according to Embodiment 3.

### DESCRIPTION OF THE EMBODIMENTS

Embodiments of the present invention will be explained next with reference to accompanying drawings. The embodiments below are not meant to limit the present invention as pertains to the claims, nor are all combinations of features explained in the embodiments necessarily essential as a solution of the present invention. Identical features will be explained using the same reference numerals.

### Embodiment 1

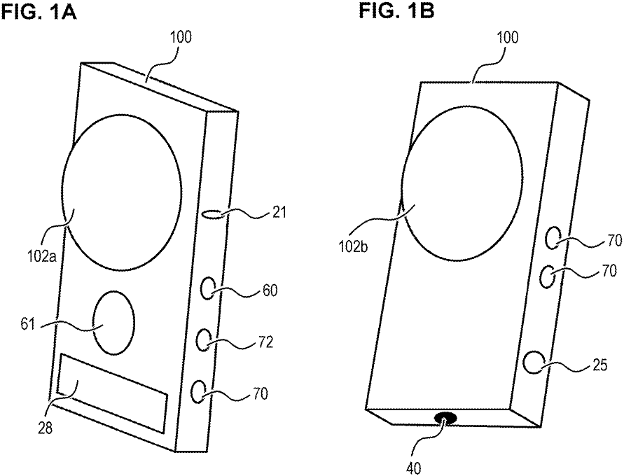

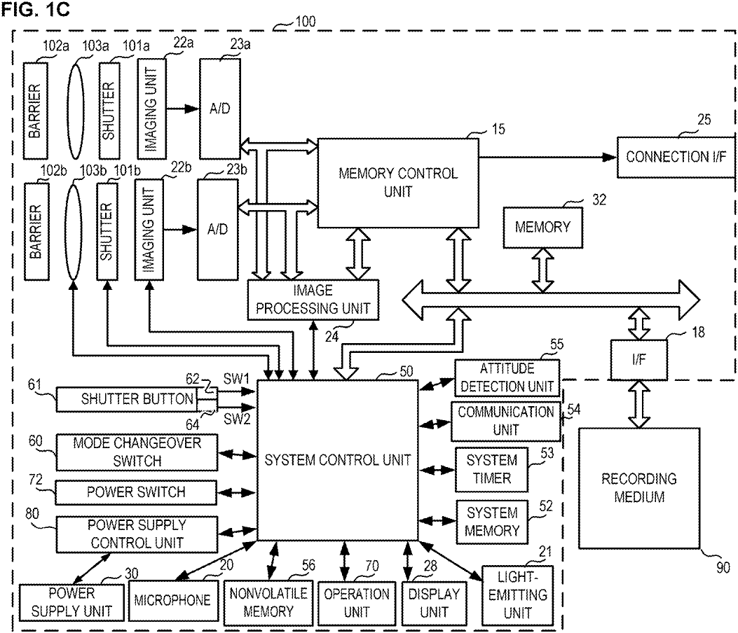

A preferred Embodiment 1 of the present invention will be explained below with reference to accompanying drawings. FIG. 1A illustrates a front perspective-view diagram (external-view diagram) of a digital camera 100 (imaging device) which is an electronic device. FIG. 1B illustrates a rear perspective-view diagram (external-view diagram) of the digital camera 100. The digital camera 100 is for instance an omnidirectional camera (spherical camera). A smartphone, a tablet terminal or the like can also be used instead of the digital camera 100.

A barrier 102a is a protective window of an imaging lens 103a for a “camera unit A” the imaging range of which lies frontward from the digital camera 100. The barrier 102a may be the outer surface of the imaging lens 103a itself. The “camera unit A” is a wide-angle camera having a wide-range imaging range of 180 degrees or more, up, down, left, and right, at the front of the digital camera 100.

A barrier 102b is a protective window for an imaging lens 103b for a “camera unit B” the imaging range of which lies rearward from the digital camera. The barrier 102b may be the outer surface of the imaging lens 103b itself. The “camera unit B” is a wide-angle camera having a wide-range imaging range of 180 degrees or more, up, down, left, and right, at the back of the digital camera 100.

A display unit 28 is a display unit that displays various types of information. A shutter button 61 is an operation unit for issuing an imaging instruction. A mode changeover switch 60 is an operation unit for switching between various modes. A connection I/F 25 is a connector between the digital camera 100 and a connection cable for connection to an external device (smartphone, personal computer, television set or the like). An operation unit 70 is an operation unit made up of operation members (various switches, buttons, dials, touch sensors and so forth) that receive various operations from a user. A power switch 72 is a press button for switching between power-on and power-off.

A light-emitting unit 21 is a light emitting member such as a light-emitting diode (LED). The light-emitting unit 21 notifies the user about various states of the digital camera 100, using emission patterns and emission colors. A fixing part 40, which is for instance a tripod screw hole, is a member for fixing to a fixing implement such as a tripod.

FIG. 1C is a block diagram illustrating a configuration example of the digital camera 100. A barrier 102a covers an imaging system of the “camera unit A” including the imaging lens 103a, of the digital camera 100, to thereby prevent the imaging system (including the imaging lens 103a, a shutter 101a and an imaging unit 22a) from being soiled or damaged. The imaging lens 103a, which is a lens group, includes a zoom lens and a focus lens. The imaging lens 103a is for instance a wide-angle lens. The shutter 101a is a shutter that has an aperture function of adjusting the amount of subject light that strikes the imaging unit 22a. The imaging unit 22a is an imaging element, for instance made up of a CCD or a CMOS element, that converts an optical image to an electric signal. An A/D converter 23a converts, to a digital signal, an analog signal outputted from the imaging unit 22a.

The barrier 102b covers an imaging system of a “camera unit B” including the imaging lens 103b, of the digital camera 100, to thereby prevent the imaging system (including the imaging lens 103b, a shutter 101b and an imaging unit 22b) from being soiled or damaged. The imaging lens 103b, which is a lens group, includes a zoom lens and a focus lens. The imaging lens 103b is for instance a wide-angle lens. The shutter 101b is a shutter having an aperture function of adjusting the amount of subject light that strikes the imaging unit 22b. The imaging unit 22b is an imaging element for instance made up of a CCD or a CMOS element, that converts an optical image to an electric signal. An A/D converter 23b converts, to a digital signal, an analog signal outputted from the imaging unit 22b.

Herein, a VR image is captured by the imaging unit 22a and the imaging unit 22b. The term VR image denotes herein an image that can be displayed in VR. The VR image can be for instance an omnidirectional image (spherical image) captured by an omnidirectional camera (spherical camera) or a panoramic image having a picture range (effective picture range) wider than the display range that can be displayed at a time on a display unit. The VR image includes not only still images, but also movies and live-view images (images acquired from a camera in substantially real time). The VR image has a picture range (effective picture range) of a field-of-view angle of 360 degrees in the top-bottom direction (vertical angle, angle from zenith, elevation angle, depression angle, altitude angle) and 360 degrees in the left-right direction (horizontal angle, azimuth angle). The VR image is set to include, even if the VR image covers less than 360 degrees vertically or 360 degrees horizontally, also an image that can be displayed at a wide angle of view (view range) that is wider than the angle of view that can be captured using a normal camera, or having a picture range (effective picture range) that is wider than the display range that can be displayed on a display unit at a time. For instance an image captured using a spherical camera capable of capturing a subject at a field-of-view angle (field angle) of 360 degrees in the left-right direction (horizontal angle, azimuth angle) and at a vertical angle of 210 degrees centered on the zenith is herein a type of VR image.

For instance an image captured using a camera capable of capturing a subject at a field-of-view angle (field angle) of 180 degrees in the left-right direction (horizontal angle, azimuth angle) and at a vertical angle of 180 degrees centered on the left-right direction is likewise herein a type of VR image. Specifically, an image having a picture range at a field-of-view angle of 160 degrees (±80 degrees) or more in the top-bottom direction and the left-right direction, or having a picture range that is wider than the range that a human can visually perceive at a time is herein a type of VR image. When this VR image is displayed in VR (display mode: “VR view”), a seamless omnidirectional picture can be viewed, in the left-right direction (horizontal rotation direction), through modification of the attitude of a display device in a left-right rotation direction. In the top-bottom direction (vertical rotation direction) a seamless omnidirectional picture can be viewed within ±105 degrees, when viewed from directly above (zenith); however, a range in excess of 105 degrees from directly above yields a blank region at which no picture is present. A VR image can also be regarded as “an image having a picture range that is at least part of a virtual space (VR space)”.

The term VR display (VR view) denotes a display method (display mode) that allows modifying a display range, in the VR image, of display of a picture within a view range according to the attitude of the display device. In a case where a head-mounted display (HMD) being a display device is worn for viewing, a picture is displayed within a view range according to the orientation of the face of the user. For instance, a picture at a view angle (angle of view) centered at 0 degrees in the left-right direction (at a specific bearing, for instance north) and at 90 degrees in the top-bottom direction (at 90 degrees from the zenith, i.e., horizontal), in the VR image, is set to be displayed at a given point in time. When the front-rear attitude of the display unit is reversed from the above state (for instance when a display surface is modified from facing south to facing north), the display range is modified, in the same VR image, to a picture at a view angle centered at 180 degrees in the left-right direction (opposite bearing, for instance south) and at 90 degrees (horizontal) in the top-bottom direction. In a case where a user who is looking into an HMD, turns his face from north to south (i.e., if the user looks back), also the picture displayed on the HMD changes over from a north picture to a south picture. Such VR display makes it possible to elicit in the user the sensation of being visually present within the VR image (within the VR space). A smartphone fitted to VR goggles (head mount adapter) can be regarded herein as a type of HMD.

The method for displaying the VR image is not limited to the above method, and the display range may be moved (scrolled) in response not to a change in attitude, but in response to an operation of the user on a touch panel, or on direction buttons. The display range may be set to be modifiable also in response to a touch-move operation on a touch panel or a drag operation of an operation member such as a mouse, also at the time of display in VR display (VR view mode), in addition to a modification of the display range derived from a change in attitude.

An image processing unit 24 performs resizing processing (processing such as predetermined pixel interpolation and reduction) and/or color conversion processing on data from the A/D converter 23a and the A/D converter 23b, or data from a memory control unit 15. The image processing unit 24 performs predetermined computational processing using the captured image data. A system control unit 50 performs exposure control and distance measurement control on the basis of the computation result obtained by the image processing unit 24. Herein TTL (through-the-lens) AF (autofocus) processing, AE (automatic exposure) processing, and EF (flash pre-emission) are performed as a result. The image processing unit 24 further performs predetermined computational processing using the captured image data, and performs TTL AWB (auto white balance) processing on the basis of the obtained computation result.

The image processing unit 24 performs basic image processing on two images (fisheye images) obtained from the A/D converter 23a and the A/D converter 23b and thereafter combines the images (stitching image processing), to thereby generate a single VR image. In the stitching image processing of two images, the image processing unit 24 detects a stitching position by calculating an offset amount between a reference image and a comparison image, for each area, by pattern matching processing in each of the two images. While factoring in the detected stitching position and the characteristics of each optical system lens, the image processing unit 24 corrects then distortion in the two images, through a geometric transformation, and converts the result into a spherical image format. The image processing unit 24 finally generates one spherical image (VR image) through blending of these two images of spherical image format. One hemispherical image (VR image) may be generated from one spherical image format image. The generated spherical image or hemispherical image (VR image) is an image that utilizes for instance equirectangular projection, such that the position of each pixel can be mapped to coordinates on the surface of a sphere. At the time of live-view VR display or at the time of playback there are also performed image clipping processing, enlargement processing, distortion correction and so forth for VR display of the VR image; also rendering for rendering on a VRAM of a memory 32 is likewise carried out.

Output data from the A/D converters 23 is written to the memory 32 via the image processing unit 24 and the memory control unit 15, or via the memory control unit 15. The memory 32 stores image data obtained by the imaging units 22 and converted to digital data by the A/D converters 23, and stores also images to be outputted from the connection I/F 25 to an external display. The memory 32 has sufficient storage capacity as to store a predetermined number of still images, as well as video and audio for a predetermined period of time.

The memory 32 also doubles as an image display memory (video memory). Image display data stored in the memory 32 can be outputted from the connection I/F 25 to an external display. The VR images (VR images captured by the imaging units 22a, 22b, generated by the image processing unit 24, and stored in the in the memory 32) are sequentially transferred to the display, where the VR images are displayed. As a result this enables live-view display (LV display) of VR images. An image displayed in live view will be referred to hereafter as an LV image. Live-view display (remote LV display) can also be carried out in which VR images stored in the memory 32 are transferred to an external device (smartphone or the like) wirelessly connected via a communication unit 54, and are displayed on the external device side.

A nonvolatile memory 56 is a memory as an electrically erasable/recordable recording medium. For instance an EEPROM is used as the nonvolatile memory 56. The nonvolatile memory 56 stores constants, programs and so forth for the operation of the system control unit 50. As used herein, the term program denotes a computer program for executing the processes of various below-described flowcharts.

The system control unit 50 is a control unit, having at least one processor or circuit, that controls the digital camera 100 as a whole. The system control unit 50 implements each process of each embodiment by executing a program recorded in the nonvolatile memory 56. For instance a RAM is used in a system memory 52. For instance constants and variables for operation of the system control unit 50, and programs that are read from the nonvolatile memory 56, are deployed in the system memory 52. The system control unit 50 also performs display control by controlling the memory 32, the image processing unit 24 and the memory control unit 15.

A system timer 53 is a timing unit that measures time (time used in various controls and time of a built-in clock).

The mode changeover switch 60, the shutter button 61 and the operation unit 70 are operation members for inputting various operation instructions to the system control unit 50. The mode changeover switch 60 switches the operation mode of the system control unit 50 to any one from among a still image recording mode, a movie capture mode, a playback mode, a communication connection mode and the like. Modes encompassed by a still image recording mode include an auto imaging mode, an auto scene discrimination mode, a manual mode, an aperture priority mode (Av mode), a shutter speed priority mode (Tv mode) and a program AE mode. Modes encompassed by the still image recording mode further include various scene modes and custom modes, which are imaging settings by imaging scene. The mode changeover switch 60 allows the user to switch directly between any of these modes. Alternatively, a list screen of imaging modes may be switched to using the mode changeover switch 60, after which any one of a plurality of modes displayed on the display unit 28 is selected, whereupon switchover is accomplished through the use of another operation member. Similarly, the movie capture mode may also include a plurality of modes.

A first shutter switch 62 is turned on through so-called half-pressing (capture preparation instruction) halfway during the operation of the shutter button 61 provided in the digital camera 100, and generates a first shutter switch signal SW1. As a result of the first shutter switch signal SW1 being thus generated, the system control unit 50 initiates an imaging preparation operation such as AF (auto focus) processing, AE (auto exposure) processing, AWB (auto white balance) processing and/or EF (flash pre-emission) processing.

A second shutter switch 64 is turned on upon completion of the operation of the shutter button 61 i.e. upon so-called full-press (imaging instruction), and generates a second shutter switch signal SW2. As a result of the second shutter switch signal SW2 being thus generated, the system control unit 50 initiates a series of imaging processing operations from signal readout from the imaging unit 22 up to writing of image data on a recording medium 90.

The shutter button 61 is not limited to a button that can be operated in two stages, i.e. full-press and half-press, and may be an operation member that can be pressed in just one stage. In that case, the imaging preparation operation and imaging processing are continuously performed upon pressing of the button in one stage. This operation is identical to the operation in the case of so-called full-pressing of a shutter button that can be half-pressed and fully-pressed (operation in a case where SW1 and SW2 are generated substantially simultaneously).

The operation members of the operation unit 70 act as various function buttons, to which functions are allocated as appropriate for each scene, for instance through selection of various function icons and options displayed on the display unit 28. Function buttons include for instance an end button, a return button, an image feed button, a jump button, a narrow-down button and an attribute modification button. For instance, a menu screen enabling various settings to be performed is displayed on the display unit 28 upon pressing of a menu button. The user can intuitively perform various settings by operating the operation unit 70 while looking at the menu screen displayed on the display unit 28.

A power supply control unit 80 is for instance made up of a battery detection circuit, a DC-DC converter and a switching circuit (circuit for switching between blocks to be energized). The power supply control unit 80 detects whether or not a battery is fitted, the type of battery, and the battery level. The power supply control unit 80 controls the DC-DC converter on the basis of the detection result and on the basis of an instruction from the system control unit 50, and supplies the necessary voltage, for a necessary period of time, to respective units (including the recording medium 90). A power supply unit 30 is for instance made up of a primary battery (such as an alkaline battery or a lithium battery), a secondary battery (such as a NiCd battery, a NiMH battery or a Li battery) and an AC adapter.

A recording medium I/F 18 is an interface with the recording medium 90 (for instance a memory card or a hard disk). The recording medium 90 is a recording medium such as a memory card for recording captured images. The recording medium 90 is for instance made up of a semiconductor memory, an optical disk or a magnetic disk. The recording medium 90 may be a replaceable recording medium that is attachable/detachable to/from the digital camera 100, or may be a recording medium built into the digital camera 100.

The communication unit 54 is connected to an external device wirelessly or by a wired cable, and exchanges for instance picture signals and audio signals with the external device. The communication unit 54 can also be connected to a wireless LAN or the Internet. The communication unit 54 can transmit images (including LV images) captured by the imaging unit 22a or the imaging unit 22b, and images recorded on the recording medium 90. The communication unit 54 can receive images and other various information from an external device.

An attitude detection unit 55 detects the attitude of the digital camera 100 with respect to the direction of gravity. On the basis of the attitude detected by the attitude detection unit 55 it becomes possible to discriminate whether an image captured by the imaging unit 22 is an image captured while the digital camera 100 was held vertically or was held horizontally. It is also possible to determine the extent of tilting in three axial directions of yaw, pitch and roll in the image captured by the imaging unit 22. The system control unit 50 can add orientation information, corresponding to the attitude detected by the attitude detection unit 55, to an image file of the VR image captured by the imaging units 22a, 22b. The system control unit 50 can also rotate an image (adjust the orientation of the image so as to correct for tilt) in accordance with the detected attitude, and can record the adjusted image. An acceleration sensor, a gyro sensor, a geomagnetic sensor, a direction sensor, an altitude sensor or the like can be used, singly or in combinations, in the attitude detection unit 55. The movement of the digital camera 100 (for instance pan, tilt, lift, and being stationary or non-stationary.) can be detected using the attitude detection unit 55 (acceleration sensor, gyro sensor, azimuth angle sensor).

The microphone 20 is a microphone that picks up sound of the surroundings of the digital camera 100 and that is to be recorded as audio of a movie of the VR image. The connection I/F 25 is a connection plug for an HDMI (registered trademark) cable, USB cable or the like, for connection to an external device and for exchange of pictures therewith.

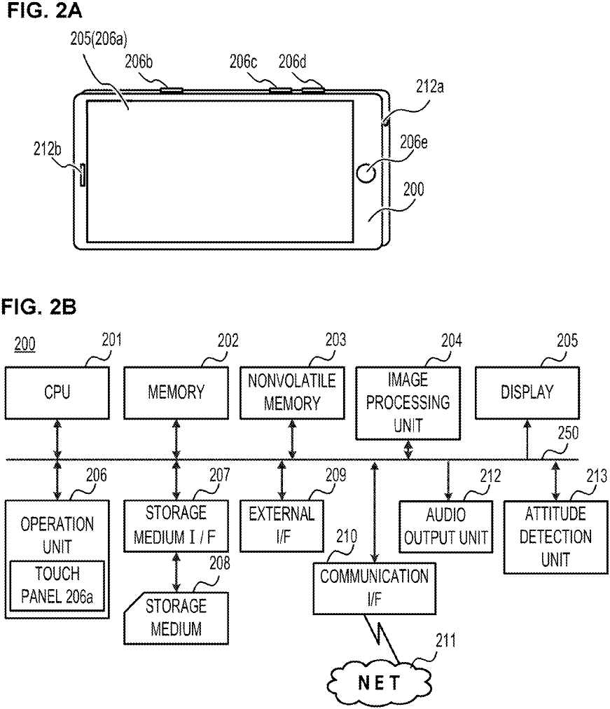

FIG. 2A illustrates an example of an external-view diagram of a display control device 200, which is a type of electronic device. A display 205 is a display unit that displays images and various information. The display 205 is configured integrally with a below-described touch panel 206a. As a result, the display control device 200 can detect a touch operation on the display surface of the display 205. The display control device 200 is capable of VR display of a VR image (VR content) on the display 205.

The operation unit 206 includes a touch panel 206a and operation units 206b, 206c, 206d, 206e. The operation unit 206b is a power button that receives an operation to switch the power of the display control device 200 on and off. The operation unit 206c and the operation unit 206d are volume buttons for increasing or decreasing the volume of audio outputted from the audio output unit 212. The operation unit 206e is a home button for displaying a home screen on the display 205. An audio output terminal 212a, which is an earphones jack, is a terminal for outputting audio to earphones, an external speaker or the like. A speaker 212b is a built-in speaker that produces sound.

FIG. 2B illustrates an example of the configuration of the display control device 200. The display control device 200 can be configured using a display device such as a smartphone. Herein a CPU 201, a memory 202, a nonvolatile memory 203, an image processing unit 204, a display 205, an operation unit 206, a storage medium I/F 207, an external I/F 209 and a communication I/F 210 are connected to an internal bus 250. Also connected to the internal bus 250 are the audio output unit 212 and an attitude detection unit 213. The units connected to the internal bus 250 can exchange data with each other via the internal bus 250.

The CPU 201, which is a control unit that controls the totality of the display control device 200, is made up of at least one processor or circuit. The memory 202 is for instance a RAM (a volatile memory that utilizes semiconductor elements or the like). The CPU 201 controls each unit of the display control device 200, using the memory 202 as a work memory, according to a program stored in the nonvolatile memory 203. The nonvolatile memory 203 stores image data, audio data, other data and various programs that are run by the CPU 201. The nonvolatile memory 203 is for instance made up of a flash memory or a ROM.

On the basis of control by the CPU 201, the image processing unit 204 performs various image processing on images (for instance images stored in the nonvolatile memory 203 and a storage medium 208, picture signals acquired via an external I/F 209, and images acquired via the communication I/F 210). Image processing performed by the image processing unit 204 includes for instance A/D conversion processing, D/A conversion processing, image data encoding processing, compression processing, decoding processing, enlargement/reduction processing (resizing), noise reduction processing and color conversion processing. The image processing unit 204 also performs various image processing, such as panorama rendering, mapping processing and conversion, on a VR image that is a wide-range image (omnidirectional image or omnidirectionally non-limited image) having wide-range data. The image processing unit 204 may be configured out of a dedicated circuit block for performing specific image processing. The CPU 201 can perform image processing according to a program, without using the image processing unit 204, depending on the type of image processing.

The display 205 displays for instance images or a GUI screen that makes up a GUI (Graphical User Interface), on the basis of control by the CPU 201. The CPU 201 generates a display control signal according to a program, and controls each unit of the display control device 200 (performs control so as to generate a picture signal for display on the display 205, and outputs the generated signal to the display 205). The display 205 displays a picture based on the picture signal. Alternatively, components of the display control device 200 itself may be configured up to an interface for outputting a picture signal to be displayed on the display 205; further, the display 205 may be configured in the form of an external monitor (such as a TV set).

An operation unit 206 is an input device for receiving user operations. The operation unit 206 includes a character information input device (keyboard or the like), a pointing device (mouse, touch panel or the like), buttons, dials, a joystick, a touch sensor or a touch pad. The touch panel is an input device, planarly configured to overlap the display 205, and which outputs coordinate information according to the touched position.

The storage medium 208 (memory card, CD or DVD) can be fitted to the storage medium I/F 207. On the basis of control by the CPU 201, the storage medium I/F 207 reads data from the fitted storage medium 208 and writes data to the storage medium 208. The external I/F 209 is an interface for connecting to an external device via a wired cable or wirelessly, and inputting/outputting picture signals and audio signals. The communication I/F 210 is an interface for communicating with an external device, a network 211 or the like, and exchanging various data such as files and commands.

The audio output unit 212 outputs for instance audio of movies and music data, operation sounds, ringtones and various notification sounds. The audio output unit 212 includes the audio output terminal 212a (terminal for connecting earphones or the like) and the speaker 212b. The audio output unit 212 may output audio for instance through wireless communication.

The attitude detection unit 213 detects the attitude of the display control device 200 with respect to the direction of gravity, and the tilt of the attitude with respect to each of the yaw, roll and pitch axes. On the basis of the attitude detected by the attitude detection unit 213 it becomes possible to discriminate whether the display control device 200 is held horizontally, held vertically, pointing upward, pointing downward, or tilted. At least one from among an acceleration sensor, a gyro sensor, a geomagnetic sensor, a direction sensor an altitude sensor and the like can be used herein in the attitude detection unit 213; also a plurality of such sensors can be used in combination.

The operation unit 206 includes the touch panel 206a. The CPU 201 can detect the following operations or states on the touch panel 206a:
The touch panel 206a is newly touched by a finger or stylus that was not touched the touch panel 206a, i.e. touching is initiated (hereafter referred to as touch-down)
State where a finger or stylus is touching the touch panel 206a (hereafter referred to as touch-on)
The finger or stylus is moving while touching the touch panel 206a (hereafter referred to as touch-move)
The finger or stylus touching the touch panel 206a moves off the touch panel 206a, i.e. touching is over (hereafter referred to as touch-up)
State where nothing touches the touch panel 206a (hereafter referred to as touch-off).

Upon detection of touch-down, also touch-on is detected at the same time. After touch-down, ordinarily, touch-on continues to be detected unless touch-up is detected. Upon detection of the touch-move, also touch-on is detected at the same time. Even if touch-on is detected, touch-move is not detected unless the touch position moves. Touch-off is detected upon detection of touch-up of all touching fingers and/or stylus.

These operations/states and the coordinates of the positions when a finger or stylus touches the touch panel 206a are notified, via an internal bus, to the CPU 201; thereupon the CPU 201 determines, on the basis of the notified information, what kind of operation (touch operation) has been performed on the touch panel 206a. For touch-move, a movement direction of a finger or a stylus moving on the touch panel 206a can be determined for each of a vertical component and a horizontal component on the touch panel 206a, on the basis of a change in position coordinates. A slide operation is deemed to have been carried out in a case where it is detected that touch-move has been performed over a predetermined or greater distance. Herein the term flick denotes an operation involving quickly moving a finger on the touch panel 206a over a certain distance, with the finger touching the touch panel 206a, and then moving the finger off. In other words, a flick is an operation in which a finger quickly traces the touch panel 206a as if flicking on the touch panel 206a. A flick can be determined to have been performed when a touch-move is detected over a predetermined or greater distance, at a predetermined or higher speed, followed by detection of touch-up (it can be determined that a flick following a slide operation has been performed).

In addition, a touch operation involving touching a plurality of locations (for example, two points) simultaneously and bringing the respective touch positions close to each other is referred to herein as pinch-in, whereas a touch operation in which the respective touch positions are moved apart from each other is referred to as pinch-out. Pinch-out and pinch-in are collectively referred to as a pinch operation (or simply pinch). As the touch panel 206a there may be used touch panels of various types, for instance of resistive film type, capacitance type, surface acoustic wave type, infrared type, electromagnetic induction type, image recognition type or optical sensor type. A scheme in which touch is detected when contact is made with the touch panel, and a scheme in which touch is detected when a finger or a stylus comes near the touch panel, may both be adopted herein.

The storage medium 208 stores data such as images for display on the display 205. The CPU 201 performs recording/reading to/from the storage medium 208 via the storage medium I/F 207.

The external I/F 209 is an interface for performing data communication with an external device, through fitting of a USB cable or the like into the display control device 200. The communication I/F 210 is an interface for data communication with the external network 211 via wireless communication.

The audio output unit 212 outputs for instance audio in the content that is played back by the display control device 200. The attitude detection unit 213 detects the attitude of the display control device 200 and notifies attitude information to the CPU 201.

### Direction Determination Processing

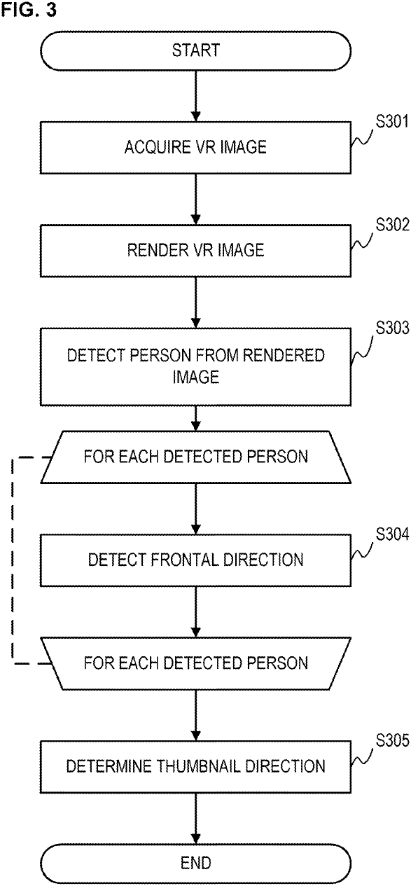

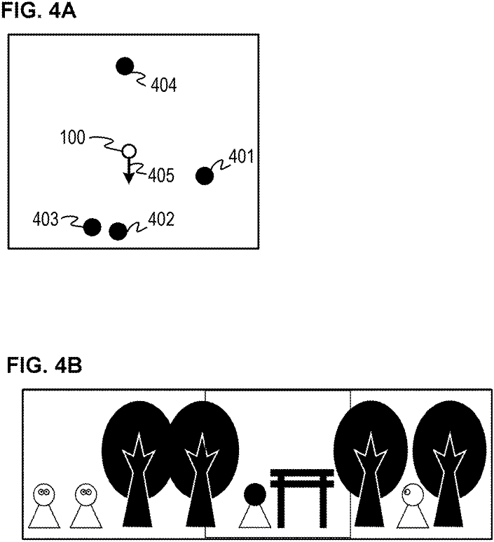

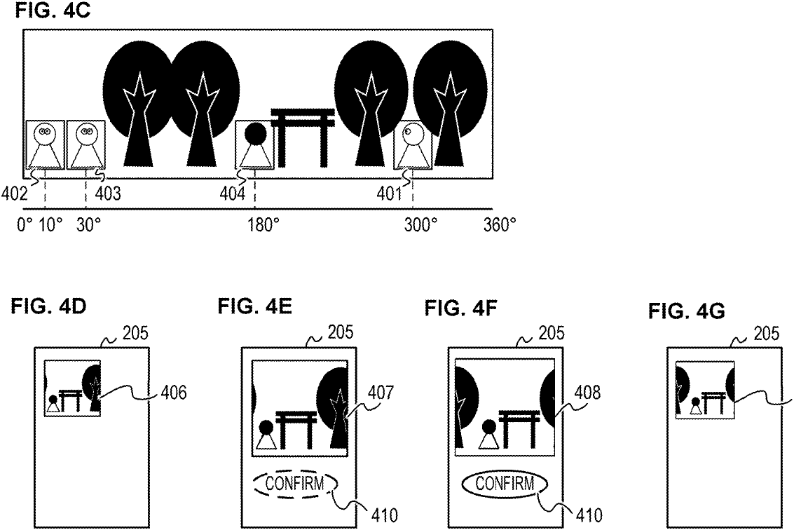

An explanation follows next, with reference to the flowchart illustrated in FIG. 3, and FIG. 4A to FIG. 4C, on processing (direction determination processing, method determination method) for determining a direction (thumbnail direction) serving as a reference for generating a thumbnail image, from a VR image (captured image; wide-angle image). Upon determination of the thumbnail direction, a range that is part of the VR image and that is captured by the digital camera 100 in the thumbnail direction (captured centering on the thumbnail direction) can be generated herein as a thumbnail image. Embodiment 1 will be explained below assuming that the digital camera 100 is an omnidirectional camera (camera capable of acquiring an omnidirectional image as a VR image).

Direction determination processing is initiated after the system control unit 50 has completed a series of imaging processes (from signal readout from the imaging unit 22 to writing of the VR image to the recording medium 90) as a result of a full-press operation (imaging instruction) of the shutter button 61 of the digital camera 100. Each process of the flowchart illustrated in FIG. 3 is realized through execution, by the system control unit 50, of a program stored in the nonvolatile memory 56. Therefore, the direction determination processing can also be regarded as a method (control method) for controlling the digital camera 100 for the purpose of determining a thumbnail direction.

FIG. 4A illustrates the positional relationship of subjects (objects) surrounding the digital camera 100 at the time of capture of a VR image. FIG. 4A is a diagram of the positional relationship of subjects (objects) as viewed from the zenith direction (from above). In FIG. 4A, persons 401 to 404, are positioned around the digital camera 100, are subjects captured by digital camera 100. Surrounding subjects other than persons are omitted in FIG. 4A.

The digital camera 100 is set up so that the optical axes of the imaging lens 103a and the imaging lens 103b are horizontal at the time of imaging. Herein a reference direction 405 of the digital camera 100 is the central direction of the imaging range frontward of the digital camera 100 (i.e. the direction towards which the optical axis of the imaging lens 103a faces). In the explanation that follows the “angle” of a given direction will be the azimuth angle in that given direction, relative to the reference direction 405 (0 degrees).

In step S301 the system control unit 50 acquires a VR image written on the recording medium 90 (captured image acquired by the digital camera 100), and stores the acquired image in the memory 32.

In step S302 the system control unit 50 renders the VR image, acquired in step S301, by equirectangular projection. Specifically, the system control unit 50 converts the VR image, by equirectangular projection, so that the reference direction 405 is 0 degrees and the ground is parallel. FIG. 4B is an image resulting from rendering, by equirectangular projection, the VR image captured by the digital camera 100, for the positional relationship illustrated in FIG. 4A. In FIG. 4B, persons 401 to 404 are lined up from left to right, given that the ground is parallel. In Embodiment 1 an example is explained in which equirectangular projection is used as a method for rendering the VR image, but other rendering methods may be used. Examples of rendering methods of VR images that can be used include Mercator projection and cylindrical equal-area projection.

In step S303 the system control unit 50 detects a person from the image having been rendered in step S302 (rendered image). For instance persons 401 to 404 having been captured as subjects are detected, as illustrated in FIG. 4C, from the rendered image illustrated in FIG. 4B.

In step S304 the system control unit 50 detects, for each of all the detected persons, the direction in which that person is facing (that person’s frontal direction) at the time of capture of the VR image.

A method for detecting the direction in which a person is facing (that person’s frontal direction) at the time of VR image capture will be explained in detail next. A given person to be processed in step S304 will be referred to hereafter as a “target person”.

Firstly the system control unit 50 determines the range of the target person appearing in the rendered image (which one from among the target person’s front, right, left and back is showing, relative to the frontal direction of the target person). The system control unit 50 determines a range of the target person (orientation of the target person) appearing in the in the rendered image, assuming that the orientation of the target person’s head is the frontal direction of the target person. For instance, in FIG. 4C the head of person 402 faces frontward, and accordingly the system control unit 50 determines that the front of person 402 is showing.

Next, the system control unit 50 acquires the direction (azimuth angle; location angle) at which the target person is positioned, with respect to the reference direction 405 (0-degree direction). In the rendered image illustrated in FIG. 4C the left end is 0 degrees, and thus person 402 is present at a position of 10 degrees. Accordingly, the system control unit 50 acquires 10 degrees as the location angle of person 402.

Thereafter, the system control unit 50 acquires the frontal direction of the target person, on the basis of the range of the target person appearing in the rendered image, and the location angle of the target person relative to the reference direction 405. In FIG. 4C the front of person 402 is showing, and the angle of location of person 402 is 10 degrees. Therefore, the system control unit 50 acquires a direction of 190 degrees (=10 degrees+180 degrees) as the frontal direction of person 402.

These processes are performed not only for person 402, but also for person 403, person 404 and person 401, in the same way. In FIG. 4C the front of person 403 is showing, and the location angle of person 403 is 30 degrees; accordingly, a direction of 210 degrees (=30 degrees+180 degrees) is acquired as the frontal direction of person 403. The back of person 404 is showing and the location angle of person 404 is 180 degrees, and accordingly a direction of 180 degrees is acquired as the frontal direction of person 404. Also, the left side of person 401 shows and the location angle is 300 degrees, and hence a direction of 210 degrees (=300 degrees-90 degrees) is acquired as the frontal direction of person 401. Specifically, there is acquired a direction of an angle resulting from adding, to the location angle, 180 degrees if the person’s front is showing, 90 degrees if the person’s right side is showing, 0 degrees if the person’s back is showing, and -90 if the person’s left side is showing.

An example has been explained herein of a determination as to whether the front, right side, left side or back of a target person is showing, but the frontal direction of the target person can be acquired with good accuracy by determining, more precisely, the range of the target person that is appears in the rendered image. The frontal direction can be detected with greater precision if the tilt of the target person relative to the digital camera 100 (i.e. the orientation of the target person in the rendered image) can be measured, rather than by determining the range of the target person showing in the rendered image.

A method other than acquisition of the orientation of the head may be resorted to as a method for detecting the frontal direction of the target person. For instance, the system control unit 50 may extract the skeleton of the target person and use, as the frontal direction of the target person, the orientation of his/her body as determined for instance from joints and from posture features. In a case where the system control unit 50 extracts the skeleton of the target person and determines thereupon that the posture of the target person matches a predetermined gesture, the system control unit 50 may detect the frontal direction of the target person in accordance with that gesture. In a case for instance where the target person is making a finger-pointing gesture, the system control unit 50 may detect the direction towards which the target person is pointing with his/her finger as the frontal direction of the target person. Alternatively, the system control unit 50 may detect the direction of the line of sight of the target person as the frontal direction of the target person.

In step S305 the system control unit 50 works out an average direction of the frontal directions of all the persons having been detected (appearing in the rendered image) in step S303, and determines that average direction as the thumbnail direction. Upon averaging of the frontal directions of person 401 to person 404 it is determined that the thumbnail direction is 197.5 degrees (average of 190 degrees, 210 degrees, 180 degrees and 210 degrees). The system control unit 50 may determine the direction of the thumbnail direction in the form of a median value or the mode of the angles of a plurality of frontal directions, instead of in the form of the average of the frontal directions. Alternatively, the system control unit 50 may detect all objects including persons, from the rendered image, and determine the thumbnail direction to be the direction of the object that is present closest to the average direction of the frontal directions of all the persons appearing in the rendered image.

The system control unit 50 may transmit the VR image and thumbnail direction information to the display control device 200 via the communication unit 54. In this case the display control device 200 having acquired the foregoing generates a thumbnail image based on the thumbnail direction, and displays the generated thumbnail image on the display 205. It is thus considered that the system control unit 50 controls the display control device 200, so as to display the thumbnail image, by transmitting information about the VR image and about the thumbnail direction to the display control device 200. At this time the display control device 200 generates, as a thumbnail image, an image within a range, of the VR image, captured by the digital camera 100 (imaging units 22a, 22b) in the thumbnail direction (space in the thumbnail direction) at the time of capture of the VR image.

The system control unit 50 may generate a thumbnail image on the basis of the VR image and the thumbnail direction. The system control unit 50 may control the display control device 200 so as to display the thumbnail image according to the thumbnail direction, by transmitting the VR image and the thumbnail image to the display control device 200. The system control unit 50 may generate a thumbnail image corresponding to the thumbnail direction, followed by display a thumbnail image on the display unit 28.

FIG. 4D illustrates an example of a thumbnail image displayed on the display 205 in a case where it is determined that the thumbnail direction is a 197.5-degree direction. In FIG. 4D a range, of VR image, captured by the digital camera 100 in a 197.5-degree direction (range in which there is captured a subject present in the 197.5-degree direction) is displayed as a thumbnail image 406.

The displayed thumbnail image may set to be adjustable through adjustment (modification) of the thumbnail direction by the user. FIG. 4E to FIG. 4G are diagrams for explaining an example of thumbnail direction adjustment by the user.

Firstly, when the user taps the thumbnail image 406 in a state where the screen illustrated in FIG. 4D is displayed, the CPU 201 displays a partial image 407 (range of the VR image in the thumbnail direction) representing a range identical to that of the thumbnail image, on the display 205 (see FIG. 4E). The CPU 201 places a confirm button 410 below a partial image 407, but this confirm button 410 is disabled (inactive state; state in which user’s operations are not accepted) until the thumbnail direction is adjusted.

Next, the user performs a drag operation on the partial image 407, whereupon the CPU 201 adjusts (modifies) the thumbnail direction in accordance with the extent (degree) of the drag operation. When the user adjusts the direction of the thumbnail (drag operation), the CPU 201 enables the confirm button 410 (active state; state in which user operations are accepted). FIG. 4F is a diagram illustrating the screen of the display 205 at a time where the user has adjusted the thumbnail direction slightly to the left (direction close to 0 degrees). In FIG. 4F a partial image 408 has changed to an image according to the thumbnail direction in response to the adjustment of the thumbnail direction.

After having adjusted the thumbnail direction, the user taps the confirm button 410, to switch to the screen illustrated in FIG. 4G on which there is displayed a thumbnail image 409 according to the adjusted thumbnail direction. Thereupon, the CPU 201 stores the adjusted thumbnail direction, as a new thumbnail direction, in the storage medium 208.

The system control unit 50 may embed information about a thumbnail direction (or thumbnail image) as metadata in the VR image stored in the recording medium 90 (storage unit). Thereafter, the system control unit 50 may transmit the VR image, having the metadata embedded therein, to the display control device 200. The system control unit 50 may hold information about the VR image and the thumbnail direction (or thumbnail image) in the recording medium 90 as mutually separate data. The system control unit 50 may store information in which the VR image and the thumbnail direction are mapped to each other, in a database or the like.

In Embodiment 1 the average direction of directions in which persons (subjects) in a VR image are facing is determined as a thumbnail direction, and a range captured in the thumbnail direction is displayed as a thumbnail image. When an object of interest is present in the field of vision, people often turn their bodies (head, fingers or the like) towards that object. In consequence, the target that the photographer intended to capture is more likely to appear in the thumbnail image if the direction of the thumbnail is determined on the basis of the direction in which a person (subject) in the VR image is facing, as in Embodiment 1. Therefore, Embodiment 1 allows conveying, to a viewer who has seen the thumbnail image, what the photographer intended to capture.

In Embodiment 1 an example has been explained in which the digital camera 100 and the display control device 200 stand as separate devices. However, the digital camera 100 may include at least part of the configuration of the display control device 200, and the digital camera 100 and the display control device 200 may be integrated together. In the above explanation the system control unit 50 executes the processes of the flowchart illustrated in FIG. 3, but it is also possible for the processes of flowchart illustrated in FIG. 3 to be executed by the display control device 200 (CPU 201) having acquired a VR image from the digital camera 100.

In Embodiment 1 an example in which the digital camera 100 is an omnidirectional camera has been explained, but the digital camera 100 may be a digital camera equipped with a fisheye lens. Also, the digital camera 100 may be a digital camera equipped with a normal lens, and which obtains a panoramic image through capture while moving the imaging direction (optical axis direction of the lens).

In Embodiment 1 the frontal direction of a person is represented by the orientation (azimuth angle) in the left-right direction; however, the frontal direction of the person can also be represented in combination also with the orientation (elevation angle) in the vertical direction (top-bottom direction). In this case, the system control unit 50 may acquire in step S305 the average of the horizontal components (azimuth angle) and the average of the vertical components (elevation angle), of the frontal directions of the persons appearing in the rendered image, so that the thumbnail direction can be determined with higher precision as a result.

### Embodiment 2

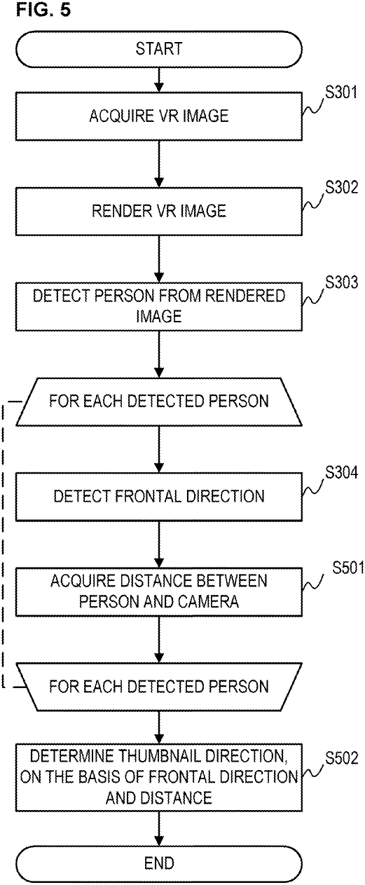

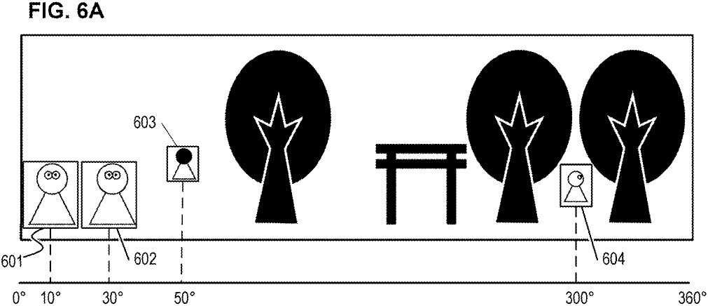

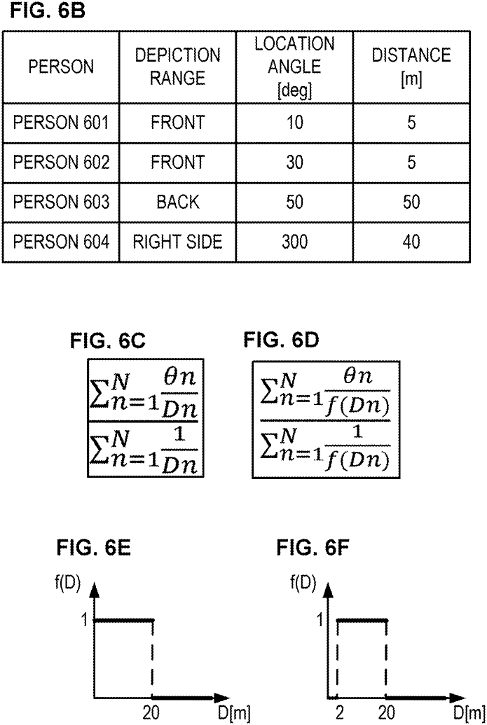

In Embodiment 1 the digital camera 100 determines the thumbnail direction through averaging of the frontal directions of the persons captured in the rendered image. In Embodiment 2, by contrast, a method for determining the thumbnail direction relying on a method that differs from that in Embodiment 1 will be explained with reference to the flowchart illustrated in FIG. 5. Steps S301 to S304 are identical to those in the direction determination processing according to Embodiment 1, and accordingly an explanation thereof will be omitted herein. Each process of the flowchart illustrated in FIG. 5 is executed through execution of the program stored in the nonvolatile memory 56 by the system control unit 50. In step S303, for instance persons 601 to 604 are detected from the rendered image, as illustrated in FIG. 6A.

Firstly, the processes in steps S304 and S501 are individually performed for all persons detected in step S303. As in Embodiment 1, a person to be processed in steps S304 and S501 is referred to as a “target person”. For instance, upon execution of the process in step S304 for each of persons 601 to 604, the frontal direction of person 601 is detected to be a direction of 190 degrees (=180 degrees+10 degrees), and the frontal direction of person 602 is detected to be a direction of 210 degrees (=180 degrees+30 degrees). Also, the frontal direction of person 603 is detected to be a direction of 50 degrees (=0 degrees+50 degrees), and the frontal direction of person 604 is detected to be a direction of 30 degrees (=390 degrees = 90 degrees+300 degrees).

In step S501 the system control unit 50 acquires the distance between the target person and the digital camera 100. The system control unit 50 acquires the distance between the target person and the digital camera 100 for instance in accordance with the size of the target person in the rendered image. The digital camera 100 may acquire information on the distance between the subject and the digital camera 100, at the time of imaging, and embed beforehand that distance information in the VR image (captured image). The system control unit 50 may then acquire the distance between the target person and the digital camera 100, in step S501, using information embedded in the VR image. Also, the digital camera 100 may save information on the distance to the subject at the time of imaging as data separate from the VR image, and use the saved information to acquire the distance between the target person and the digital camera 100. The system control unit 50 may analyze the rendered image, and acquire the distance to the subject on the basis of imaging conditions. The table illustrated in FIG. 6B sets out the depiction range, the location angle, and the distance from the digital camera 100, for each of persons 601 to 604 illustrated in FIG. 6A.

In step S502 the system control unit 50 determines a thumbnail direction on the basis of the frontal direction of each person in the rendered image and on the basis of the distance from the digital camera to each person. Herein, the system control unit 50 acquires a weighted average of the frontal directions of the persons using the reciprocal of the distance as a weight. For instance, an n-th person out of N persons stands herein at a frontal direction angle of θn, at a distance Dn from the digital camera 100. Such being the case an expression for calculating a weighted average with weights in the form of the reciprocal of distance can be derived as given in FIG. 6C. For instance, a weighted average result of about 184 degrees is obtained when substituting in the expression given in FIG. 6C the distances according to the table illustrated in FIG. 6B and the frontal direction angles detected in step S304. Therefore, in step S502 the system control unit 50 can determine a direction of about 184 degrees as the thumbnail direction.

$$\frac{\frac{190}{5} + \frac{210}{5} + \frac{50}{50} + \frac{30}{40}}{\frac{1}{5} + \frac{1}{5} + \frac{1}{50} + \frac{1}{40}} = 183.707865 …$$

In Embodiment 2 a method has been explained of acquiring a weighted average using the reciprocal of the distance as a weight, but other calculation methods may be resorted to. For instance, a function f(D) may be used that has a distance D as the argument and that is defined so that f(D1)>f(D2) holds when D1>D2 (so that f(D)≠0 for any D). Specifically, the thumbnail direction as given in the expression illustrated in FIG. 6D may be determined using the function f(D).

The function f(D) may be a discontinuous function such as that illustrated in FIG. 6E. When a discontinuous function such as that illustrated in FIG. 6E is used in the expression illustrated in FIG. 6D, the thumbnail direction is determined through averaging of the frontal directions of persons within 20 m from the digital camera 100.

When the function f(D) is defined as a function illustrated in FIG. 6F, the average of the frontal directions of persons whose distance from the digital camera 100 ranges from 2 m to 20 m is determined in the thumbnail direction. It becomes possible as a result to preclude the use of the frontal direction of the photographer in the determination of the thumbnail direction, in a case where the photographer is capturing images while holding the digital camera 100 in his/her hand.

In Embodiment 2, the system control unit 50 applies thus weighting using the distances between persons and the digital camera 100, and determines, as the thumbnail direction, a direction resulting from averaging of frontal directions. As a result, the system control unit 50 can determine the thumbnail direction by emphasizing the direction towards which persons standing near the photographer are facing, those persons being very likely facing in the same direction as the direction of interest of the photographer. In Embodiment 2, therefore, the subject that the photographer intends to capture is more likely to appear within the thumbnail image.

### Embodiment 3

In Embodiment 1 and Embodiment 2 the digital camera 100 determines a single thumbnail direction. In Embodiment 3, by contrast, the digital camera 100 determines multiple thumbnail directions. In the explanation below only the part of step S305, in the direction determination processing illustrated in FIG. 3, differs from that in Embodiment 1, and accordingly only the detailed process in step S305 will be described.

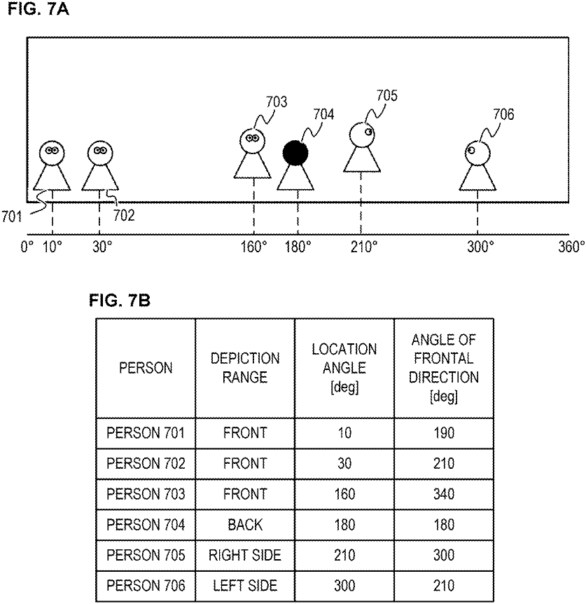

FIG. 7A is a diagram illustrating a rendered image and persons 701 to 706 appearing in the rendered image (VR image), in Embodiment 3. FIG. 7B is a table containing the depiction range, location angle and frontal direction (facing direction) of person 701 to person 706.

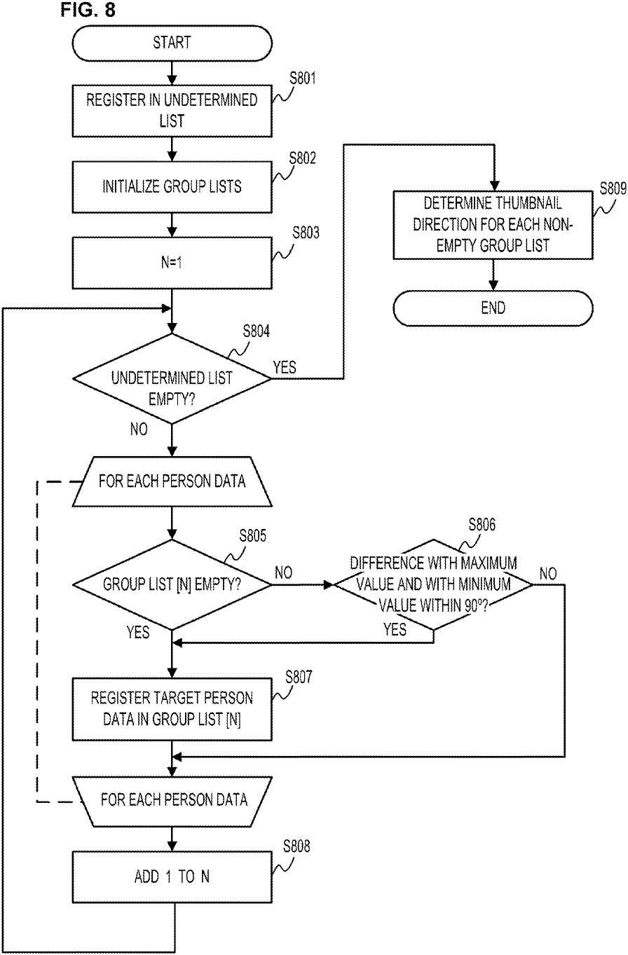

FIG. 8 is a flowchart for explaining in detail the process in step S305 according to Embodiment 3. Each process of the flowchart illustrated in FIG. 8 is executed through execution of the program stored in the nonvolatile memory 56 by the system control unit 50.

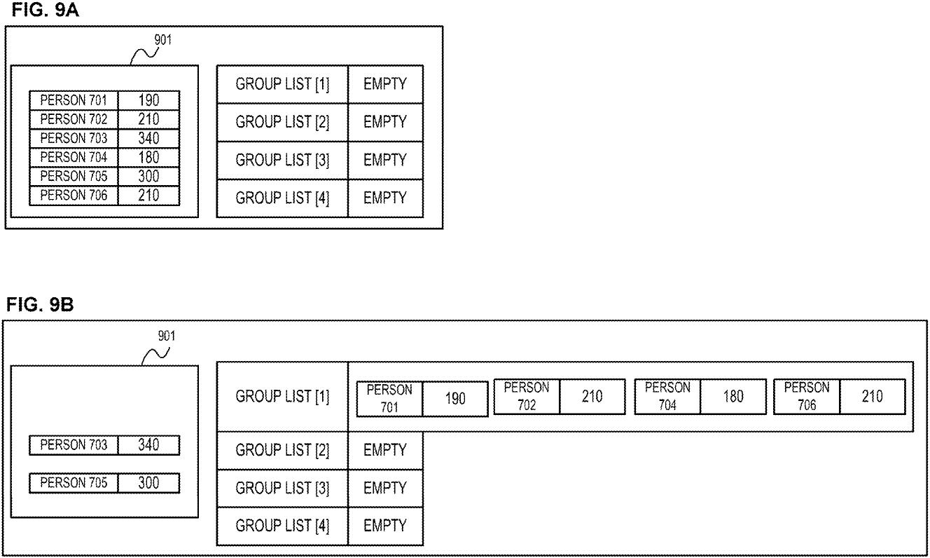

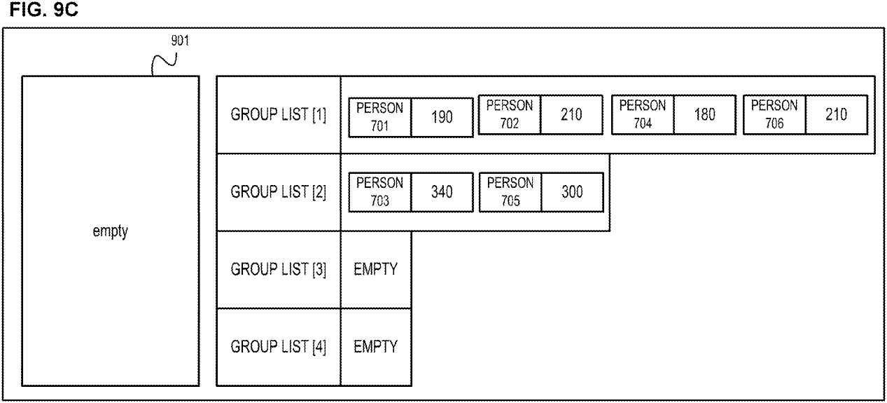

An explanation follows next on an example in which plurality of person data sets (persons) are classified as into groups using data (hereafter referred to as “person data”) in the form of a set of information of a person appearing in the rendered image and the frontal direction (frontal direction angle) of that person. The memory 32 has an “undetermined list” as a list in which there is registered person data not classified into a group. The memory 32 has group list [1] through group list [4] in which there is registered person data belonging to each group (see FIG. 9A to FIG. 9C). The number of group lists need not be four, and may be any number equal to or greater than two.

In step S801 the system control unit 50 registers (stores), in the undetermined list, person data of all persons detected in step S303. For instance in a case where a person is detected on the basis of the rendered image, as illustrated in FIG. 7A, person data of persons 701 to 706 are registered in an undetermined list 901, as illustrated in FIG. 9A.

In step S802 the system control unit 50 initializes all group lists [1]-[4]. That is, the system control unit 50 empties all group lists [1]-[4]. Once the process in step S802 is over, none of the group lists [1]-[4] contains even a single piece of person data, as illustrated in FIG. 9A.

In step S803 the system control unit 50 sets to 1 (initializes) a group number N denoting the number of the group list.

In step S804 the system control unit 50 determines whether the undetermined list is empty or not (does not include even a single person data item). In a case where the undetermined list is empty, the process proceeds to step S809. In a case where the undetermined list is not empty, the system control unit 50 performs individually the process of steps S805 to S807 (for instance sequentially from the top of the undetermined list) for the person data included in the undetermined list. Thereafter the person data to be processed in steps S805 to S807 will be referred to as “target person data”.

In step S805 the system control unit 50 determines whether a group list [N] is empty or not (does not include a single person data item). If it is determined that the group list [N] is empty, the process proceeds to step S807. If it is determined that the group list [N] is not empty, the process proceeds to step S806.

In step S806 the system control unit 50 acquires maximum and minimum values of frontal direction angle in the person data included in the group list [N]. The system control unit 50 determines whether or not a difference between the frontal direction angle in the target person data and the acquired maximum value lies within 90 degrees, and whether or not the difference between the frontal direction angle in the target person data and the acquired minimum value lies within 90 degrees. If it is determined that both differences lie within 90 degrees, the process proceeds to S807. If it is determined that either of the two differences is not within 90 degrees, there end the process in steps S805 to S807 for the target person data.

In step S806 it is determined whether the two differences are within 90 degrees or not, but also a value smaller than 90 degrees may be used herein. The smaller this value, the smaller is ordinarily the number of person data items included in one group list, which entails a greater number of thumbnail directions that are determined.

In step S807 the system control unit 50 newly registers the target person data in the group list [N]. That is, it can be said that the system control unit 50 classifies the target person data (person denoted by the target person data) into a group belonging to the group list [N]. The system control unit 50 deletes the target person data from the undetermined list.

Once the processes in steps S805 to S807 have been performed on all person data included in the undetermined list, the process proceeds to step S808. The width (degree; value) of the range of the frontal direction angle of the plurality of person data included in one group list (difference between the minimum value and maximum value of the angle) can be kept within 90 degrees (predetermined width) as a result of the processes in steps S805 to S807 being performed in the above manner.

In step S808 the system control unit 50 increments the group number N by one. Once the process in step S808 ends, the process returns to step S804.

In step S809 the system control unit 50 determines, for each group list (group) that is not empty (including person data), an average of frontal directions in the person data (person) included in the group list, as the thumbnail direction. The system control unit 50 can determine as a result thumbnail directions for the number of group lists including person data.

FIG. 9B illustrates the state of the undetermined list 901 and the group lists [1]-[4] at the time of start of the process in step S808, upon completion of registration (steps S805 to S807) of person data in the group list [1], on the basis of the information illustrated in FIG. 7B. Person data of person 703 and person 705 remain in the undetermined list 901. By contrast, the person data of person 701, person 702, person 704 and person 706 are registered (stored) in group list [1].

FIG. 9C illustrates the undetermined list 901 and the group lists [1]-[4] at the time of start of the process in step S808 upon completion of storage of person data in group list [2]. In the state illustrated in FIG. 9C the undetermined list 901 is empty; once the process in step S808 ends, therefore, the process proceeds from step S804 to step S809.

In a hypothetical case where the person data of person 706 whose frontal direction is a 20-degree direction is stored in the undetermined list 901, these 20 degrees can be regarded as 380 degrees. Accordingly, also a difference between the frontal direction angle of person 706 and either a maximum value 340 or a minimum value 300 of the frontal direction angle in group list [2] illustrated in FIG. 9C lies within 90 degrees. Therefore, person data denoting person 706 is registered in group list [2].

In step S809 the system control unit 50 calculates the average of the frontal directions (the frontal directions of persons linked to person data) stored in group list [1] illustrated in FIG. 9C; thereupon, a direction of an angle of about 198 degrees can be determined as the thumbnail direction. Similarly, a direction of an angle of 320 degrees is determined as the thumbnail direction for group list [2].

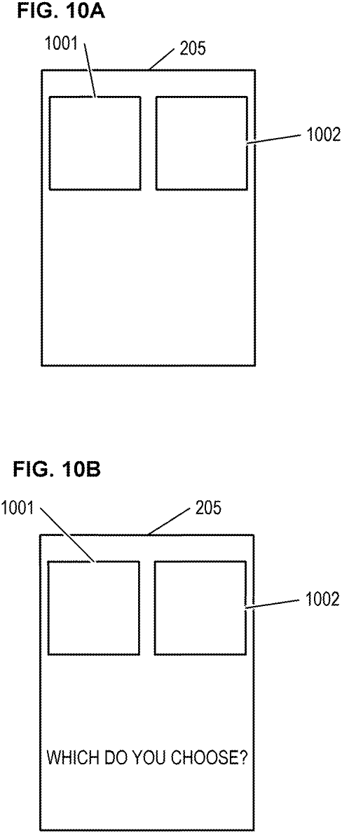

The display control device 200 may display (present) a plurality of thumbnail images according to a plurality of thumbnail directions thus determined. FIG. 10A is an example in which thumbnail images corresponding to respective thumbnail directions acquired as a result of the processing of the flowchart illustrated in FIG. 8 are displayed on the display 205 of the display control device 200. A thumbnail image 1001 is a thumbnail image according to the thumbnail direction corresponding to group list [1]. A thumbnail image 1002 is a thumbnail image according to the thumbnail direction corresponding to group list [2].

The display control device 200 may be configured so that the user can select one thumbnail direction (thumbnail image). For instance as illustrated in FIG. 10B, the display control device 200 may present multiple thumbnail images, for selection by the user. The display control device 200 for instance stores, in the storage medium 208, a thumbnail direction corresponding to the selected thumbnail image, as the thumbnail direction corresponding to the VR image.

In FIG. 10A and FIG. 10B thumbnail images corresponding to the thumbnail direction determined according to Embodiment 1 or Embodiment 2 may be displayed along with the thumbnail image 1001 and the thumbnail image 1002.

Any method of classification into groups may be resorted to herein, besides the method for classifying into groups explained in Embodiment 3. For instance a clustering method may be resorted to.

In Embodiment 3 the system control unit 50 classifies one or more persons appearing in the VR image into one or more groups, and determines a thumbnail direction for each group. Persons facing the same direction are classified herein as belonging to the same group. Therefore, Embodiment 3 allows determining a thumbnail direction denoting the direction in which a target can be present, for each target, also in a case where the attentions of multiple persons are distributed over a plurality of targets.

Instead of the average of values of frontal direction angle of each person, the “average” in the embodiments may be a value indicated by a direction (compound direction) resulting from averaging unit vectors denoting respective frontal directions of the persons. In a case where the angle exceeds 180 degrees, an angle obtained by subtracting 360 degrees from the given angle may be used instead. Specifically, -90 degrees may be used instead of 270 degrees, and -30 degrees may be used instead of 210 degrees.

In the embodiments, the system control unit 50 determines (establishes) a thumbnail direction in accordance with the directions in which persons are facing. However, the system control unit 50 may determine the thumbnail direction in accordance with the facing direction of an “animal”, instead of a “person”. That is, an arbitrary subject can be used instead of the “person” if the subject has a habit of gazing in a specific direction in response to the external environment (for instance a robot that faces in a direction in which bright light is generated).

In the above embodiments the display control device 200 displays a thumbnail image according to a thumbnail direction, but the thumbnail direction need not necessarily be used for display of a thumbnail image. For instance in playback of a VR image by the display control device 200, a thumbnail direction may be used for determining the range of the VR image to be displayed on the display 205. Specifically, the display control device 200 may control the initial range of the VR image to be displayed on the display 205 at the start of playback so as to be a range according to the thumbnail direction.

The present invention succeeds thus in providing a technique which, upon display of a partial range of a wide-angle image, that allows accurately and easily inform a viewer about a range that a photographer intends to capture.

The present invention has been explained in detail on the basis of preferred embodiments thereof, but the present invention is not limited to these specific embodiments, and encompasses also various implementations without departing from the gist of the invention. Parts of the embodiments explained above may be combined with each other as appropriate.

A feature wherein “in a case where A is equal to or greater than B, the process proceeds to step S1, while in a case where A is smaller (lower) than B, the process proceeds to step S2” may be read as “in a case where A is larger (higher) than B, the process proceeds to step S1, while in a case where A is equal to or smaller than B, the process proceeds to step S2”. Conversely, a feature wherein “In a case where A is larger (higher) than B, the process proceeds to step S1, and in a case where A is equal to or smaller than B, the process proceeds to step S2” may be read as “in a case where A is equal to or greater than B, the process proceeds to step S1, while in a case where A is smaller (lower) than B, the process proceeds to step S2”. Accordingly, so long as no contradiction arises in doing so, the language “equal to or greater than A” may be read as “larger (higher, longer, more numerous) than A”, and the language “equal to or smaller than A” may be read as “smaller (lower, shorter, less numerous) than A”. The language “larger (higher, longer, more numerous) than A” may be read as “equal to or greater than A”, and the language “smaller (lower, shorter, less numerous) than A” may be read as “equal to or smaller than A”.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An electronic device comprising:
a processor; and a memory storing a program which, when executed by the processor, causes the electronic device to
acquire a wide-angle image; and
in a case where the wide-angle image includes a specific object, perform control so as to display, on a screen, a partial range of the wide-angle image, being a range of a direction in which the specific object is facing, in the wide-angle image.

2. The electronic device of claim 1, wherein, in a case where the wide-angle image includes a plurality of specific objects,
the program when executed by the processor causes the electronic device to perform control so as to display, on the screen, a range of an average direction of directions in which the specific objects are facing, and being a partial range of the wide-angle image.

3. The electronic device of claim 1,the program when executed by the processor causes the electronic device to perform control so as to display, on the screen, the range based on the direction in which the specific object is facing and a distance between the specific object and an imaging device that has captured the wide-angle image.

4. The electronic device of claim 3, wherein, in a case where the wide-angle image includes a plurality of specific objects,
the program when executed by the processor causes the electronic device to perform control so as to display, on the screen, a range of a direction which is a weighted average of directions in which the specific objects are facing, on a basis of distances between the plurality of specific objects and the imaging device.

5. The electronic device of claim 1, wherein a direction in which an object is facing is an orientation of a head of the object.

6. The electronic device of claim 1, wherein a direction in which an object is facing is a direction in which a finger of the object is pointing.

7. The electronic device of claim 1, wherein a direction in which an object is facing is a direction of a line of sight of the object.

8. The electronic device of claim 1, wherein the program when executed by the processor causes the electronic device to determine the direction in which the specific object is facing, on a basis of a position of the specific object in a rendered image resulting from rendering the wide-angle image, and a range of the specific object shown in the rendered image.

9. The electronic device of claim 8, wherein the rendered image is an image resulting from rendering the wide-angle image by equirectangular projection, Mercator projection, or cylindrical equal-area projection.

10. The electronic device of claim 1, wherein, in a case where the wide-angle image includes a plurality of specific objects,
the program when executed by the processor causes the electronic device to
classify the plurality of specific objects into one or a plurality of groups, on a basis of directions in which the specific objects are facing; and
perform control so as to display on the screen, for each classified group, a partial range of the wide-angle image, being a range based on one or more directions in which one or more specific objects belonging to the group is facing.

11. The electronic device of claim 10, wherein the program when executed by the processor causes the electronic device to, for each of the plurality of groups, classify the plurality of specific objects so that a difference between a maximum and a minimum of directions in which one or more specific objects belonging to the group are facing is smaller than a predetermined value.

12. The electronic device of claim 1, wherein the program when executed by the processor causes the electronic device to
in a case where the wide-angle image includes the specific object, generate, as a thumbnail image, an image of a partial range within the wide-angle image, being a range in the direction in which the specific object is facing in the wide-angle image.

13. The electronic device of claim 12, wherein the program when executed by the processor causes the electronic device to perform control so as to record the thumbnail image, on a recording medium, embedded as metadata in the wide-angle image.

14. The electronic device of claim 12, wherein the program when executed by the processor causes the electronic device to perform control so as to record the thumbnail image, on a recording medium, associated with the wide-angle image.

15. The electronic device of claim 1, wherein the specific object is a person.

16. The electronic device of claim 1, wherein the wide-angle image is a spherical image or a hemispherical image.

17. An electronic device control method comprising:
an acquisition step of acquiring a wide-angle image; and
a control step of, in a case where the wide-angle image includes a specific object, performing control so as to display, on a screen, a partial range of the wide-angle image, being a range of a direction in which the specific object is facing, in the wide-angle image.

18. A non-transitory computer readable medium that stores a program, wherein the program causes a computer to execute a control method of an electronic device, the control method comprising:
an acquisition step of acquiring a wide-angle image; and
a control step of, in a case where the wide-angle image includes a specific object, performing control so as to display, on a screen, a partial range of the wide-angle image, being a range of a direction in which the specific object is facing, in the wide-angle image.
